(19) United States
(12) Patent Application Publication
(10) Pub. No.: US 2020/0022358 A1
(43) Pub. Date: Jan. 23, 2020

(54) TUNED DUCK CALL

(71) Applicant: Killian Bailey, Terre Haute, IN (US)

(72) Inventor: Killian Bailey, Terre Haute, IN (US)

(21) Appl. No.: 16/516,412

(22) Filed: Jul. 19, 2019

Related U.S. Application Data
(60) Provisional application No. 62/700,958, filed on Jul. 20, 2018.

(51) Int. Cl. A01M 31/00; G10K 5/00

(52) U.S. Cl. CPC A01M 31/004; G10K 5/00

(57) ABSTRACT

A duck call including a sounding portion, a reed coupled to the sounding portion, and a mouthpiece. The mouthpiece body has the sounding portion inserted therein. At least one of the sounding portion and the mouthpiece body having an outer wall with an internal infill pattern. The internal infill pattern has at least one cross-sectional lattice structure with a repeating pattern of voids.

### CROSS REFERENCE TO RELATED APPLICATIONS

This is a non-provisional application based upon U.S. provisional patent application Ser. No. 62/700,958, entitled “TUNED DUCK CALL”, filed Jul. 20, 2018, which is incorporated herein by reference.

### BACKGROUND OF THE INVENTION

### 1. Field of the Invention

The present invention relates to a duck call, and, more particularly, to a duck call having an internal construction that serves to tune the duck call.

### 2. Description of the Related Art

A duck call is a whistle type device made to emulate the sound of a duck. Early duck calls were simple woodwind instruments with a barrel, a sounding board and a reed. Hunters would blow into the call while saying “hut”, “wuit”, or “oak” to make the single quack. In order for a hunter to make a feeding call, they can say a quick repetition of “tiki-tika” or “duga-duga”. With the improvement of calls and calling techniques the more experienced callers now do not use their voice as a part of the calling technique, but simply blow, with no words being spoken, into the call.

Duck calls are typically made from wood or acrylic. Among the difference between wood and acrylic duck calls is that acrylic calls are typically much louder and the sound carries much further than wood duck calls. Acrylic calls are often preferred in large, open spaces with the louder call being effective at longer distances. Most acrylic calls are single reed calls, since they are typically much louder than double reed calls. When hunting in a timbered or swampy area, a wood call is often preferred. Another difference is that acrylic calls are known to have less sound variance over typical temperature ranges.

Wood duck calls generally have a softer, muted, deep tone. These calls and the sounds they produce work better for ducks that are closer to the hunter and in quiet environments. A drawback of the wood duck call is that the wood can swell when exposed to moisture or humidity, which can lead to an altered tone being produced from the call.

Plastic duck calls do not typically swell from moisture but they are generally more dense than wood calls and will sink when dropped in water. Duck calls are typically constructed as solid bodies of uniform material and depend upon a change in the geometry of the tone board, a change in the air passageway or a change in the reed configuration (shape and number) to change the tone of the duck call.

What is needed in the art is a way of constructing a duck call to control the tone quality in a non-traditional manner and to be a lightweight product.

### SUMMARY OF THE INVENTION

The present invention provides a duck call with tuned tonal attributes.

The invention in one form is directed to a duck call including a sounding portion, a reed coupled to the sounding portion, and a mouthpiece. The mouthpiece body has the sounding portion inserted therein. At least one of the sounding portion and the mouthpiece body having an outer wall with an internal infill pattern. The internal infill pattern has at least one cross-sectional lattice structure with a repeating pattern of voids.

The invention in another form is directed to a duck call including a sounding portion, a reed coupled to the sounding portion, and a mouthpiece. The mouthpiece body has the sounding portion inserted therein. At least one of the sounding portion and the mouthpiece body have an outer wall with a non-homogeneous infill stratified such that a density and a stiffness of the sound portion and/or the mouthpiece body vary along an axis of the duck call thereby altering a tone or sound producible by the sounding portion.

The invention in yet another form is directed to a duck call including a sounding portion, a reed coupled to the sounding portion, and a mouthpiece. The mouthpiece body has the sounding portion inserted therein. At least a portion of the mouthpiece body or the sounding portion have an infill that has a density below a specific gravity of 1.

An advantage of the present invention is that the duck call is lightweight in construction and will float in water.

Another advantage is that the tone of the duck call is managed by the internal construction of the call

Yet another advantage is that the infill can vary over the extent of the call to allow the creation of a tuned duck call.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of a variable density tuned duck call of the present invention;

FIG. 2 is a perspective view of the variable density tuned duck call of FIG. 1 with the sounding box partially withdrawn from the mouthpiece;

FIG. 3 is a side view of the sounding box of FIGS. 1 and 2;

FIG. 4 is a cross-sectional view of either the mouthpiece or the sounding box of FIGS. 1-3, having inner and outer walls;

FIG. 5A is a cross-sectional view of an infill pattern used in the space between the inner and the outer walls of FIG. 4;

FIG. 5B is another cross-sectional view of another infill pattern used in the space between the inner and the outer walls of FIG. 4;

FIG. 5C is another cross-sectional view of yet another infill pattern used in the space between the inner and the outer walls of FIG. 4;

FIG. 5D is another cross-sectional view of still yet another infill pattern used in the space between the inner and the outer walls of FIG. 4;

FIG. 5E is another cross-sectional view of even another infill pattern used in the space between the inner and the outer walls of FIG. 4;

FIG. 5F is another cross-sectional view of even another infill pattern used in the space between the inner and the outer walls of FIG. 4;

FIG. 6 is a cross-sectional view of a part of the sounding piece of FIGS. 1-3; and

FIG. 7 is a schematical representation of a transition between two infill patterns used in the variable density duck call of FIGS. 1-3.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Referring now to the drawings, and more particularly to FIG. 1, there is shown a variable density tuned duck call 10 having a mouthpiece 12 and a sounding box 14 (also known as an insert 14). The construct of elements 12 and 14 being part of the inventive nature of the present invention.

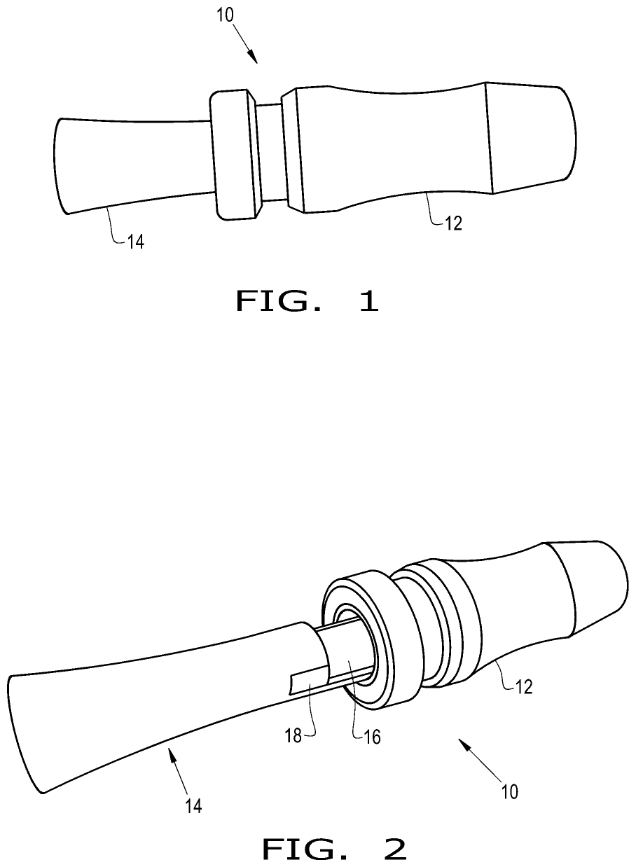

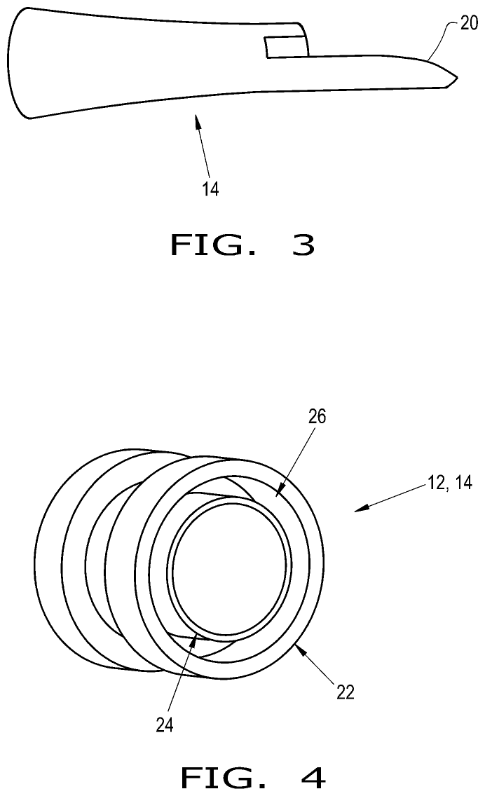

Now, additionally referring to FIG. 2, there is shown sounding piece 14 removed from mouthpiece 12 to reveal a reed 16 and a reed retaining insert 18. Insert 18 holds reed 16 in place in sounding piece 14. Now, additionally referring to FIG. 3, there is illustrated sounding piece 14 with reed 16 removed to show tone board 20, which can provide a varying support depending upon the infill of insert 14.

Now, additionally referring to FIG. 4, there is shown a cross-section of either mouthpiece 12 or insert 14 having an outer wall 22, an inner wall 24 and space 26 within which an infill can exist, having a desirable geometry. Inner and outer walls 22 and 24 are non-porous and the infill (later designated as item 28) can be of an open or closed cell configuration. It is also contemplated that walls 22 and/or 24 may be somewhat porous or have selective openings therethrough to space 26 and the associated infill.

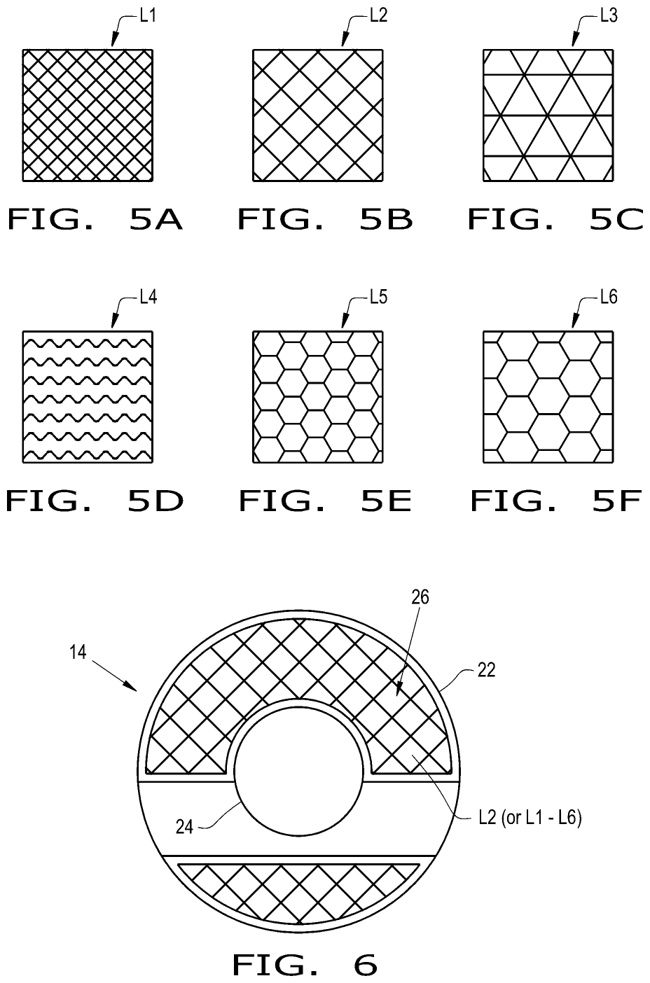

Now, additionally referring to FIG. 5 A-F there are shown various patterns which the infill can take. The examples illustrated are representative of patterns and are not to be considered to be limited to just the specific displayed geometries.

Now, additionally referring to FIG. 6, there is shown a view of an insert 14 where an infill 28 is positioned within walls 22 and 24. Infill 28 can have a non-oriented geometry, or can be ordered to have repeating patterns in a longitudinal, axial or cross-sectional orientation. It is also contemplated that space 26 may have a selective gas sealed therein that extends through at least a portion of infill 28. The geometry of infill 28 may be made by way of a 3-D printer. The geometry allows for variable density to impact the resonance of members 12 and 14, or to impact the support structures, such as tone board 20, to have a variable strength and stiffness. Infill 28 can be changed in shape, direction, size as well as density to alter the mechanical properties, tone and range of tones for duck call 10.

It is also contemplated that infill 28 can be configured such that at least some of the interior cell walls of infill 28 are altered by exterior forces, such as a biting pressure of the user, or a twisting motion, so that resonance and tone are altered thereby.

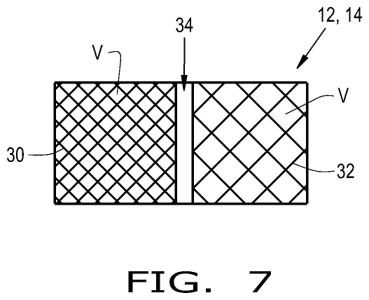

Now, additionally referring to FIG. 7 there is schematically illustrated a variable density in a wall of item 12 or 14 with a first configuration of infill 28 at location 30 and a different configuration of infill 28 at location 32. The configuration difference and transition between locations 30 and 32 may be a change in geometry, material, wall thickness, porosity, material distribution and/or other property of infill 28.

Advantageously the present invention is easily configured to customize a duck call 10, and due to the open cavities within infill 28 allow call 10 to have a light weight to thereby float in water. The present invention additionally allows for surface shapes of internal features such as tone board 20, which can be configured to prevent the sticking of the reed due to moisture on tone board 20.

Duck call 10 has a reed 16 coupled to sounding portion 14. Mouthpiece body 12 has sounding portion 14 inserted therein. The sounding portion 14 and/or the mouthpiece body 12 having an outer wall 22 with an internal infill 26 pattern, the internal infill 26 pattern having at least one cross-sectional lattice structure L1, L2, L3, L4, L5 or L6 with a repeating pattern of voids V.

The infill 26 has a varying density that directly alters a stiffness of the sounding portion 14 thereby altering a sound produced by sounding portion 14. The lattice structure L1-6 has a repeating geometric pattern as seen in FIGS. 5A-5F, which are representative of a multitude of patterns that can be used. While the lattice structure can include several patterns, within duck call 10 more than one pattern can be utilized with a transition zone 34 being between two patterns 30 and 32 that have differing patterns. The lattice structures 30 and 32 can have similar geometric patterns of differing sizes, or they can have differing geometric patterns L1-L6. The transition zone 34 can be a wall separating the first lattice structure 30 from the second lattice structure 32. Further, the transition zone 34 can be an area where the first lattice structure 30 morphs into the second lattice structure 32 with at least some of the voids V in the first lattice structure 30 being open to at least some of the voids V of the second lattice structure 32.

Sounding portion 14 and/or mouthpiece body 12 can have an outer wall with a non-homogeneous infill 26 stratified such that a density and a stiffness of sound portion 14 and/or mouthpiece body 12 vary along a longitudinal axis of the duck call thereby altering a tone or sound producible by sounding portion 14. Sounding portion 14 can have infill 26 that is of a varying density, which directly alters the stiffness of the sounding portion 14 thereby altering a sound produced by sounding portion 14.

Another aspect of duck call 10 has at least some portion of the mouthpiece body or the sounding portion that has an infill 26 that has a density below a specific gravity of 1. The density and distribution of a variable density and/or the geometrical patterns of infill 26 serves to alter the sound due to the way infill 26 interacts with vibrations from reed 16. The more dense or stiffer duck call 10 is, the harder it would be, which creates a louder and crisper tone. If the material of infill 26 is less dense, then duck call 10 will create a mellower tone.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A duck call, comprising:
a sounding portion;
a reed coupled to the sounding portion; and
a mouthpiece body into which the sounding portion is inserted, at least one of the sounding portion and the mouthpiece body having an outer wall with an internal infill pattern, the internal infill pattern having at least one cross-sectional lattice structure with a repeating pattern of voids.

2. The duck call of claim 1, wherein the sounding portion has an infill with a varying density that directly alters a stiffness of the sounding portion thereby altering a sound produced by the sounding portion.

3. The duck call of claim 1, wherein the lattice structure has a repeating geometric pattern.

4. The duck call of claim 1, wherein the lattice structure includes a first lattice structure and a second lattice structure, the first lattice structure forming one portion of the sounding portion and/or the mouthpiece which transitions to the second lattice structure at a transition zone, the second lattice structure forming an other portion of the sounding portion and/or the mouthpiece, the first lattice structure having a differing pattern than the second lattice structure.

5. The duck call of claim 4, wherein the first lattice structure and the second lattice structure have similar geometric patterns of differing sizes.

6. The duck call of claim 4, wherein the first lattice structure and the second lattice structure have differing geometric patterns.

7. The duck call of claim 4, wherein the transition zone is a wall separating the first lattice structure from the second lattice structure.

8. The duck call of claim 4, wherein the transition zone is an area where the first lattice structure morphs into the second lattice structure with at least some of the voids in the first lattice structure being open to at least some of the voids of the second lattice structure.

9. A duck call, comprising:
a sounding portion;
a reed coupled to the sounding portion; and
a mouthpiece body into which the sounding portion is inserted, at least one of the sounding portion and the mouthpiece body having an outer wall with a non-homogeneous infill stratified such that a density and a stiffness of the sound portion and/or the mouthpiece body vary along an axis of the duck call thereby altering a tone or sound producible by the sounding portion.

10. The duck call of claim 9, wherein the sounding portion has an infill with a varying density that directly alters a stiffness of the sounding portion thereby altering a sound produced by the sounding portion.

11. The duck call of claim 9, wherein the non-homogeneous infill includes at least one lattice structure having a repeating geometric pattern.

12. The duck call of claim 11, wherein the lattice structure includes a first lattice structure and a second lattice structure, the first lattice structure forming one portion of the sounding portion and/or the mouthpiece which transitions to the second lattice structure at a transition zone, the second lattice structure forming an other portion of the sounding portion and/or the mouthpiece, the first lattice structure having a differing pattern attribute than the second lattice structure.

13. The duck call of claim 12, wherein the differing pattern attribute is that the two lattice structures have similar geometric patterns of differing sizes.

14. The duck call of claim 12, wherein the differing pattern attribute is that the two lattice structures have differing geometric patterns.

15. The duck call of claim 12, wherein the transition zone is a wall separating the first lattice structure from the second lattice structure.

16. The duck call of claim 12, wherein the transition zone is an area where the first lattice structure morphs into the second lattice structure having at least some of voids in the first lattice structure being open to at least some voids of the second lattice structure.

17. A duck call, comprising:
a sounding portion;
a reed coupled to the sounding portion; and
a mouthpiece body into which the sounding portion is inserted, a portion of the mouthpiece body or the sounding portion having an infill that has a density below a specific gravity of 1.

18. The duck call of claim 17, wherein the infill has a varying density that directly alters a stiffness of the sounding portion thereby altering a sound produced by the sounding portion.

19. The duck call of claim 18, wherein the infill is non-homogeneous and includes at least one lattice structure having a repeating geometric pattern.

20. The duck call of claim 19, wherein the lattice structure includes a first lattice structure and a second lattice structure, the first lattice structure forming one portion of the sounding portion and/or the mouthpiece which transitions to the second lattice structure at a transition zone, the second lattice structure forming an other portion of the sounding portion and/or the mouthpiece, the first lattice structure having a differing pattern attribute than the second lattice structure.
